(19) United States
(12) Patent Application Publication
(10) Pub. No.: US 2009/0255967 A1
(43) Pub. Date: Oct. 15, 2009

(54) Collapsible Storage Container for Pick-up Truck or SUV

(76) Inventor: Christopher R. Lueder, Midland, MI (US)

Correspondence Address: Christopher R. Lueder, 2699 W. Prairie Rd., Midland, MI, 48640, US

(21) Appl. No.: 12/102,795

(22) Filed: Apr. 14, 2008

(51) Int. Cl. B60R 9/00

(52) U.S. Cl. 224/404

(57) ABSTRACT

A utility box container primarily used in pick-ups or SUV's that will allow better utilization of the full truck bed by being able to access the back of the bed. The container is generally from four feet to eight feet in length and wide enough to allow two to three units to be used together, the dimensions depend on the pick-up bed length it is to be used in. The box is also collapsible. The ability to collapse the container in place in the bed of the truck allows for placing large objects into the pick-up bed without the need to remove the container. The large objects can be placed directly on top of the collapsed box.

### BACKGROUND OF THE INVENTION

This invention relates to pick-up truck and SUV utility or storage containers that require no mechanical fastening to the vehicle itself.

The forward area of the pick-up bed is generally difficult to access making it typically unused space that could be better utilized for routine day to day type activities. Many pick-up trucks come standard with a cover or top that covers the bed of truck or the covers are installed later to keep the contents secure and out of the rain or snow. The bed covers by nature make the forward space of the bed even more difficult to access.

Current storage containers designed for pick-up trucks have several disadvantages. Typically they are mechanically fastened or built into the vehicle requiring sometimes complicated and costly installations and are equally difficult to remove later if needed. Also, they may restrict the area available in the truck bed when large items may need to be placed in the bed of the pick-up. Typical boxes that could be used to store items in the forward area of the pick-up bed are not made in right dimensions as they either are not long enough to allow it to slide easily into the furthest area of the truck bed or are not collapsible and would require complete removal of the box to allow the bed to be used for large objects. Removal and storage of a fixed dimension container can frequently become an issue if away from home.

It is desirable to have a utility/storage box that allows full utilization of the forward area of the pick-up truck bed to keep objects accessible without climbing into the rear of the truck to retrieve the items or container. In conjunction with this functionality it is necessary to maintain the ability to place large objects in the bed of the truck without the need to remove the utility box to do so.

The specific folding design mechanism of the box is not important; it is the combination of the application, dimension, and foldable characteristic that provides a unique invention to utilize the bed of a pick-up while not impeding any overall capability of the bed to handle larger objects.

From the following detailed description and attached drawings the unique advantages of the invention in the application of pick-up truck or SUV bed will be apparent.

### DETAILED DESCRIPTIONS OF THE DRAWINGS AND INVENTION

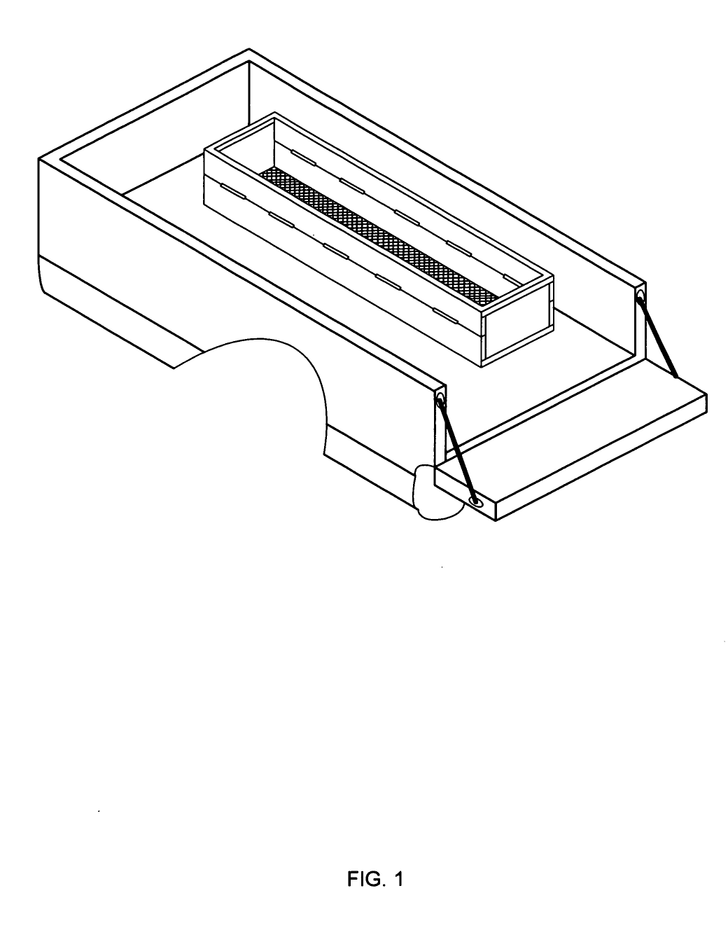

FIG. 1 is a drawing showing the rear of a typical pick-up truck bed with the utility box invention expanded fully and placed inside. This would be the normal position for using the invention to store items.

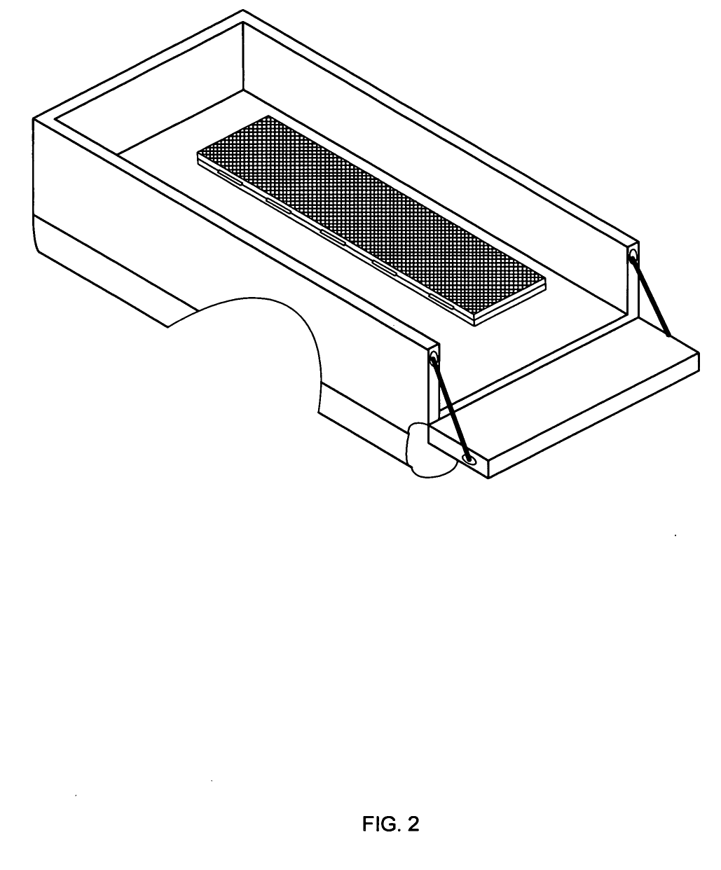

FIG. 2 is a drawing showing the rear of a typical pick-up truck bed with the utility box invention placed inside but collapsed and upside down providing an even surface to slide larger items on top of it. This would be the position of the invention when the pick-up truck bed is needed to be used for holding large objects.

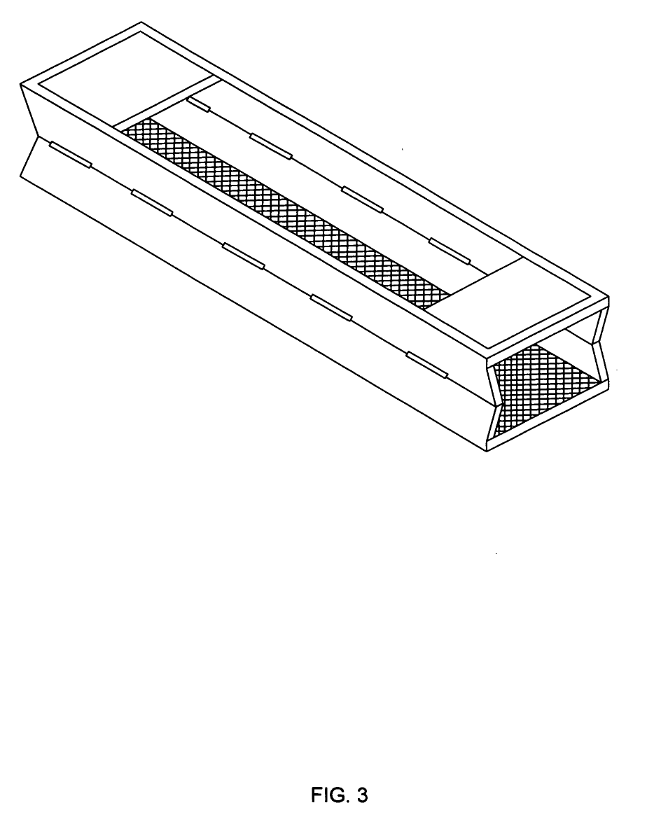

FIG. 3. is a drawing showing the invention partially collapsed, this is simply to show the transition of the box from FIG. 1 to FIG. 2. The method or mechanism by which the box collapses is only an example and various collapsible designs could be used.

The box shown in the 3 figures can be pulled backwards out of pick-up bed and have items placed into it. It could have dividers installed to allow segregation of items being stored. It can be reached from the rear of the pick-up and pulled and pushed in and out as needed. The width and lengths involved can vary to allow the best access as well as provide the right width dimension so that two to three boxes could be placed side by side effectively and used independently. By collapsing all of the boxes in the bed as shown in FIG. 2., it provides a solid surface with a low height allowing the sliding of larger items in and out of the pick-up bed without removal of the box(s).

The descriptions above describe the preferred configuration of the invention in its present state. The present invention is susceptible to modification and alteration without deviating from the scope of the claims.

1. A collapsible storage container for a pick-up truck bed that is long enough to allow it to slide into the forward area of the bed, typically 4 to 8 feet in length, thereby allowing this area to be better utilized for storage while being able to easily retrieve the container by standing at the rear of the vehicle
Upon being collapsed it allows larger items to be placed on top of it eliminating the need to remove it from the bed of the pickup in order to transport larger items.
This configuration provides a novel storage container for use in pick-up trucks which provides an effective method for utilizing the full area of the pick-up bed.
Other boxes and containers designed for use as storage containers for pick-ups do not have the proper length for accessibility or, if so, is not collapsible thus forcing removal of the box from the bed in order to use the bed for larger objects.
This unit will provide both functions for this particular applications need.
